(19) United States
(12) Patent Application Publication
(10) Pub. No.: US 2023/0021733 A1
(43) Pub. Date: Jan. 26, 2023

(54) BICYCLE COMPONENT, NON-CONTACT CHARGING SYSTEM AND NON-CONTACT CHARGING METHOD

(71) Applicant: Shimano Inc., Osaka (JP)

(72) Inventors: Susumu ENDO, Osaka (JP); Shinichiro NODA, Osaka (JP); Yuusuke NISHIKAWA, Osaka (JP); Yuichiro HIDAKA, Osaka (JP); Noor Ashyikkin BINTI MOHD NOOR, Osaka (JP)

(21) Appl. No.: 17/833,401

(22) Filed: Jun. 6, 2022

(30) Foreign Application Priority Data
Jul. 22, 2021 (DE) 102021118985.3
Feb. 28, 2022 (DE) 102022104745.3

(51) Int. Cl. B60L 1/14; B60L 53/12; B60L 58/10; B60L 53/20; B62J 43/30; H02J 7/00; H02J 50/80; H02J 7/02; H02J 50/10

(52) U.S. Cl. CPC B60L 1/14; B60L 53/12; B60L 58/10; B60L 53/20; B62J 43/30; H02J 7/0063; H02J 50/80; H02J 7/0047; H02J 7/02; H02J 50/10; H02J 2207/20

(57) ABSTRACT

A bicycle component is provided other than a rear derailleur and a drive unit. The bicycle component includes an electrical part, a rechargeable power source and a non-contact charging portion. The rechargeable power source is electrically connected to the electrical part. The non-contact charging portion is configured to wirelessly receive external electric power and to supply the external electric power to the rechargeable power source. A non-contact charging method is also provided for charging the rechargeable power source of the bicycle component.

### CROSS-REFERENCE TO RELATED APPLICATIONS

This application claims priority to German Patent Application No. 10 2021 118 985.3, filed on Jul. 22, 2021, and German Patent Application No. 10 2022 104 742.3, filed on Feb. 28, 2022. The entire disclosures of German Patent Application Nos. 10 2021 118 985.3 and 10 2022 104 742.3 are hereby incorporated herein by reference.

### BACKGROUND

### Technical Field

This disclosure generally relates to a bicycle component other than a rear derailleur and a drive unit, a non-contact charging system including a bicycle component, and a non-contact charging method for charging a bicycle component.

### Background Information

In recent years, some bicycles are provided with electrical bicycle components or devices to make it easier for the rider to operate the bicycle. Examples of such electrical bicycle components include suspensions, transmission devices (e.g., derailleurs, internally geared hubs, etc.) and seatposts. Such electrical bicycle components use electricity from an onboard power source, such as one or more batteries. The power source for the bicycle component either needs to be replaced or needs to be periodically recharged. In the case of where power source for the bicycle component needs to be periodically recharged, either the battery is plugged into a remote charger, or the battery is removed from the bicycle component and placed on a remote charger.

Recently, some electrical devices are charged using a wireless charging technique that use an electromagnetic field to transfer energy between two or more devices based on inductive coupling. A charging station or charger is used to generate the electromagnetic field to transmit electromagnetic energy that is generated by the electromagnetic field. The device to be charged receives the electromagnetic energy through resonant inductive coupling, and converts the electromagnetic energy to electrical energy to charge a power supply of the device to be charged.

### SUMMARY

Generally, the present disclosure is directed to various features of recharging a bicycle component other than a rear derailleur and a drive unit that is recharged in a non-contact manner.

In view of the state of the known technology and in accordance with a first aspect of the present disclosure, a bicycle component is provided other than a rear derailleur and a drive unit. The bicycle component basically comprises an electrical part, a rechargeable power source and a non-contact charging portion. The rechargeable power source is electrically connected to the electrical part. The non-contact charging portion is configured to wirelessly receive external electric power and to supply the external electric power to the rechargeable power source.

With the bicycle component according to the first aspect, the rechargeable power source of the bicycle component can be conveniently charged without using an electrical cable connecting the rechargeable power source to a charging device.

In accordance with a second aspect of the present disclosure, the bicycle component according to the first aspect further comprises a wireless communicator that is configured to communicate with a non-contact charging device.

With the bicycle component according to the second aspect, the bicycle component can communicate with the non-contact charging device to appropriately charge the rechargeable power source of the bicycle component.

In accordance with a third aspect of the present disclosure, the bicycle component according to the first aspect or the second aspect further comprises a sensor configured to detect information relating to a condition of the rechargeable power source.

With the bicycle component according to the third aspect, the rechargeable power source of the bicycle component can be appropriately charged and/or controlled based on the detected condition of the rechargeable power source by the sensor.

In accordance with a fourth aspect of the present disclosure, the bicycle component according to the third aspect is configured so that the sensor includes a temperature sensor configured to detect a temperature of the rechargeable power source.

With the bicycle component according to the fourth aspect, it is possible to determine the electrical load of the rechargeable power source using the temperature of the rechargeable power source.

In accordance with a fifth aspect of the present disclosure, the bicycle component according to the third or fourth aspect is configured so that the sensor includes a voltage sensor configured to detect at least one of a voltage of the rechargeable power source and a voltage supplied to the rechargeable power source.

With the bicycle component according to the fifth aspect, it is possible to easily monitor the recharging of the rechargeable power source and to determine an appropriate time for starting and stopping the recharging process of the rechargeable power source.

In accordance with a sixth aspect of the present disclosure, the bicycle component according to any one of the first aspect to the fifth aspect further comprises an AC/DC converter disposed between the non-contact charging portion and the rechargeable power source.

With the bicycle component according to the sixth aspect, it is possible to recharge the rechargeable power source with direct current from the alternating current of the non-contact charging portion.

In accordance with a seventh aspect of the present disclosure, the bicycle component according to any one of the first aspect to the sixth aspect further comprises a controller configured to adjust at least one of a voltage supplied to the rechargeable power source and a voltage supplied to the electrical part.

With the bicycle component according to the seventh aspect, it is possible to protect the bicycle component from overheating by adjust at least one of a voltage supplied to the rechargeable power source and a voltage supplied to the electrical part.

In accordance with an eighth aspect of the present disclosure, the bicycle component according to any one of the first aspect to the seventh aspect further comprises a controller configured to monitor at least one of voltage of the rechargeable power source and voltage of the electrical part after a prescribed period of time elapsing from a start of the charging.

With the bicycle component according to the eighth aspect, it is possible to easily determine an appropriate time for changing the recharging mode of rechargeable power source, and/or changing the restrictions on one or more of the operating functions of the bicycle component.

In accordance with a ninth aspect of the present disclosure, the bicycle component according to any one of the first aspect to the eighth aspect further comprises a controller configured to restrict an operating function of the electrical part upon determining a parameter of the rechargeable power source is outside of a permissible range. The controller is configured to maintain the operating function of the electrical part upon determining the parameter of the rechargeable power source is inside of the permissible range.

With the bicycle component according to the ninth aspect, it is possible to converse electric power and/or protect the electrical part from overheating.

In accordance with a tenth aspect of the present disclosure, the bicycle component according to any one of the first aspect to the ninth aspect is configured so that the bicycle component is one of an operating device, an adjustable seatpost, an adjustable suspension, an adjustable front derailleur, a lamp, and an object holder.

With the bicycle component according to the tenth aspect, it is possible to appropriately control and recharge of bicycle components such as an operating device, an adjustable seatpost, an adjustable suspension, an adjustable front derailleur, a lamp, and an object holder.

In accordance with an eleventh aspect of the present disclosure, the bicycle component according to any one of the first aspect to the tenth aspect is configured so that the electrical part includes an electrical switch configured to output an electrical signal to operate an external device.

With the bicycle component according to the eleventh aspect, the bicycle component can be used to operate an external device.

In accordance with a twelfth aspect of the present disclosure, the bicycle component according to the eleventh aspect further comprises an operating member configured to activate the electrical switch.

With the bicycle component according to the twelfth aspect, it is possible for a user to easily activate the electrical switch using an operating member.

In accordance with a thirteenth aspect of the present disclosure, a non-contact charging system is provided that comprises the bicycle component according to any one of the first aspect to the twelfth aspect, and further comprises a non-contact charging device including a non-contact charging portion configured to wirelessly transmit electric power to the bicycle component.

With the non-contact charging system according to the thirteenth aspect, the bicycle component can be wirelessly recharged by a non-contact charging device.

In accordance with a fourteenth aspect of the present disclosure, a non-contact charging method is provided for charging a rechargeable power source of a bicycle component. The non-contact charging method comprises starting wireless communication between the bicycle component and a non-contact charging device; detecting a condition of the rechargeable power source; confirming a parameter of the rechargeable power source based on a result of the condition that was detected; and charging the rechargeable power source of the bicycle component.

With the non-contact charging method according to the fourteenth aspect, the rechargeable power source of the bicycle component can be conveniently charged without using an electrical cable connecting the rechargeable power source to a charging device.

In accordance with a fifteenth aspect of the present disclosure, the non-contact charging method according to the fourteenth aspect further comprises restricting an operating function of the bicycle component upon determining a parameter of the rechargeable power source is outside of a permissible range, and maintaining the operating function of the bicycle component upon determining the parameter of the rechargeable power source is inside of the permissible range.

With the non-contact charging method according to the fifteenth aspect, it is possible to converse electric power and/or protect the electrical part from overheating when the parameter of the rechargeable power source is outside of a permissible range by restricting an operating function of the bicycle component, and maintain normal operating function of the bicycle component when the parameter of the rechargeable power source is inside of the permissible range.

In accordance with a sixteenth aspect of the present disclosure, the non-contact charging method according to the fifteenth aspect further comprises adjusting a voltage of the rechargeable power source upon determining the parameter of the rechargeable power source is outside of the permissible range.

With the non-contact charging method according to the sixteenth aspect, it is possible to protect the rechargeable power source from over heating during the recharging process.

In accordance with a seventeenth aspect of the present disclosure, the non-contact charging method according to the sixteenth aspect further comprises monitoring the voltage of the rechargeable power source after a prescribed period of time elapsing from a start of the charging.

With the non-contact charging method according to the seventeenth aspect, it is possible to easily determine an appropriate time for changing the recharging mode of rechargeable power source, and/or changing the restrictions on one or more of the operating functions of the bicycle component.

In accordance with an eighteenth aspect of the present disclosure, the non-contact charging method according to any one of the fourteenth aspect to the seventeenth aspect further comprises detecting a temperature of the rechargeable power source as the condition.

With the non-contact charging method according to the eighteenth aspect, it is possible to determine the electrical load of the rechargeable power source using the temperature of the rechargeable power source.

In accordance with a nineteenth aspect of the present disclosure, the non-contact charging method according to any one of the fourteenth aspect to the eighteenth aspect further comprises converting alternating current from a non-contact charging portion to direct current that is supplied to the rechargeable power source.

With the non-contact charging method according to the nineteenth aspect, it is possible to recharge the rechargeable power source with direct current from the alternating current of the non-contact charging portion.

In accordance with a twentieth aspect of the present disclosure, the non-contact charging method according to any one of the fourteenth aspect to the nineteenth aspect is configured so that the bicycle component is one of an operating device, an adjustable seatpost, an adjustable suspension, an adjustable front derailleur, a lamp, and an object holder.

With the non-contact charging method according to the twentieth aspect, the recharging method can be used to appropriately control and recharge of bicycle components such as an operating device, an adjustable seatpost, an adjustable suspension, an adjustable front derailleur, a lamp, and an object holder.

In accordance with a twenty-first aspect of the present disclosure, a bicycle component is provided other than a rear derailleur and a drive unit. The bicycle component basically comprises a base member and a power receiver. The a base member is configured to be mounted to a bicycle. The power receiver is mounted to the base member. The power receiver includes a non-contact charging portion configured to wirelessly receive external electric power and to supply the external electric power to at least one of a rechargeable power source and an electrical component.

With the bicycle component according to the twenty-first aspect, to at least one of a rechargeable power source and an electrical component of a bicycle can be conveniently charged.

In accordance with a twenty-second aspect of the present disclosure, the bicycle component according to the twenty-first aspect is configured so that the base member includes a support portion configured to support the power receiver.

With the bicycle component according to the twenty-second aspect, the power receiver can be conveniently located on the base member of the bicycle component.

In accordance with a twenty-third aspect of the present disclosure, the bicycle component according to the twenty-first aspect or the twenty-second aspect is configured so that the bicycle component is one of an operating device, an adjustable seatpost, an adjustable suspension, an adjustable front derailleur, and a lamp, and an object holder.

With the bicycle component according to the twenty-third aspect, it is possible to appropriately recharge of bicycle components such as an operating device, an adjustable seatpost, an adjustable suspension, an adjustable front derailleur, a lamp, and an object holder.

In accordance with a twenty-fourth aspect of the present disclosure, the bicycle component according to any one of the twenty-first aspect to the twenty-third aspect is configured so that the power receiver includes an electrical cord that is configured to supply the external electric power to the at least one of the rechargeable power source and the electrical component.

With the bicycle component according to the twenty-fourth aspect, the external electric power is efficiently supplied to the at least one of the rechargeable power source and the electrical component via an electrical cord.

In accordance with a twenty-fifth aspect of the present disclosure, the bicycle component according to any one of the twenty-first aspect to the twenty-fourth aspect further comprises an AC/DC converter disposed between the non-contact charging portion and the at least one of the rechargeable power source and the electrical component.

With the bicycle component according to the twenty-fifth aspect, it is possible to supply the at least one of the rechargeable power source and the electrical component with direct current from the alternating current of the non-contact charging portion.

In accordance with a twenty-sixth aspect of the present disclosure, the bicycle component according to any one of the twenty-first aspect to the twenty-fifth aspect is configured so that the rechargeable power source is disposed in the power receiver.

With the bicycle component according to the twenty-sixth aspect, the rechargeable power source can be conveniently located and an external electrical cord between the power receiver and the rechargeable power source can be omitted.

In accordance with a twenty-seventh aspect of the present disclosure, the bicycle component according to any one of the twenty-first aspect to the twenty-sixth aspect is configured so that the power receiver includes a waterproof structure accommodating the non-contact charging portion.

With the bicycle component according to the twenty-seventh aspect, the electrical parts of the power receiver can be protected from water and other contaminants.

In accordance with a twenty-eighth aspect of the present disclosure, a non-contact charging system comprises the bicycle component according to any one of the twenty-first aspect to the twenty-seventh aspect, and further comprises a non-contact charging device including a housing configured to be supported by the base member, and a transmitter configured to wirelessly transmit electric power to the non-contact charging portion.

With the bicycle component according to the twenty-eighth aspect, the at least one of the rechargeable power source and the electrical component can be wirelessly recharged by a non-contact charging device.

Also, other objects, features, aspects and advantages of the disclosed bicycle component, the non-contact charging system and the disclosed non-contact charging method will become apparent to those skilled in the art from the following detailed description, which, taken in conjunction with the annexed drawings, discloses preferred embodiments of the disclosed bicycle component, the non-contact charging system and the disclosed non-contact charging method.

### BRIEF DESCRIPTION OF THE DRAWINGS

Referring now to the attached drawings which form a part of this original disclosure:

FIG. 1 is a side elevational view of a first bicycle that is equipped with a plurality of bicycle components (e.g., an operating device, an adjustable front derailleur and a lamp) in accordance with illustrated embodiments of the present disclosure;

FIG. 2 is a side elevational view of a second bicycle that is equipped with a plurality of bicycle components (e.g., an adjustable seatpost, an adjustable suspension and a lamp) in accordance with illustrated embodiments of the present disclosure;

FIG. 3 is an overall schematic block diagram of a bicycle component system including a bicycle component and a non-contact charging device in accordance with illustrated embodiments of the present disclosure;

FIG. 4 is a side elevational view of the adjustable front derailleur of the bicycle illustrated in FIG. 1;

FIG. 5 is a side elevational view of the adjustable rear derailleur of the bicycle illustrated in FIG. 1;

FIG. 6 is a side elevational view of the right operating device of the bicycle illustrated in FIG. 1;

FIG. 7 is a side elevational view of the adjustable seatpost of the bicycle illustrated in FIG. 1;

FIG. 8 is a side elevational view of the adjustable suspension of the bicycle illustrated in FIG. 1;

FIG. 9 is a side elevational view of the adjustable suspension of the bicycle illustrated in FIG. 1;

FIG. 10 is a side elevational view of an object holder (e.g., a water bottle cage) attached to a portion of the bicycle illustrated in FIG. 1;

FIG. 11 is a flowchart of a control process executed by the controller of the bicycle component for contactless charging of the bicycle component via the non-contact charging device while the bicycle is traveling;

FIG. 12 is a flowchart of a control process executed by the controller of the bicycle component for contactless charging of the bicycle component via the non-contact charging device while the bicycle is stopped or the bicycle component is not installed on the bicycle;

FIG. 13 is a flowchart of a control process executed by the controller of the bicycle component for determining when to start the contactless charging of the bicycle component via the non-contact charging device while the bicycle is traveling.

FIG. 14 is a side elevational view of an object holder (e.g., a water bottle cage) attached to a portion of the bicycle illustrated in FIG. 1 in which a non-contact charging device is in a process of being inserted into the object holder;

FIG. 15 is a side elevational view of the object holder (e.g., a water bottle cage) illustrated in FIG. 14 in which the non-contact charging device has been inserted into the object holder; and

FIG. 16 is an overall schematic block diagram of a bicycle component system including an object holder (e.g., a water bottle cage) and a non-contact charging device in accordance with illustrated embodiments of the present disclosure.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

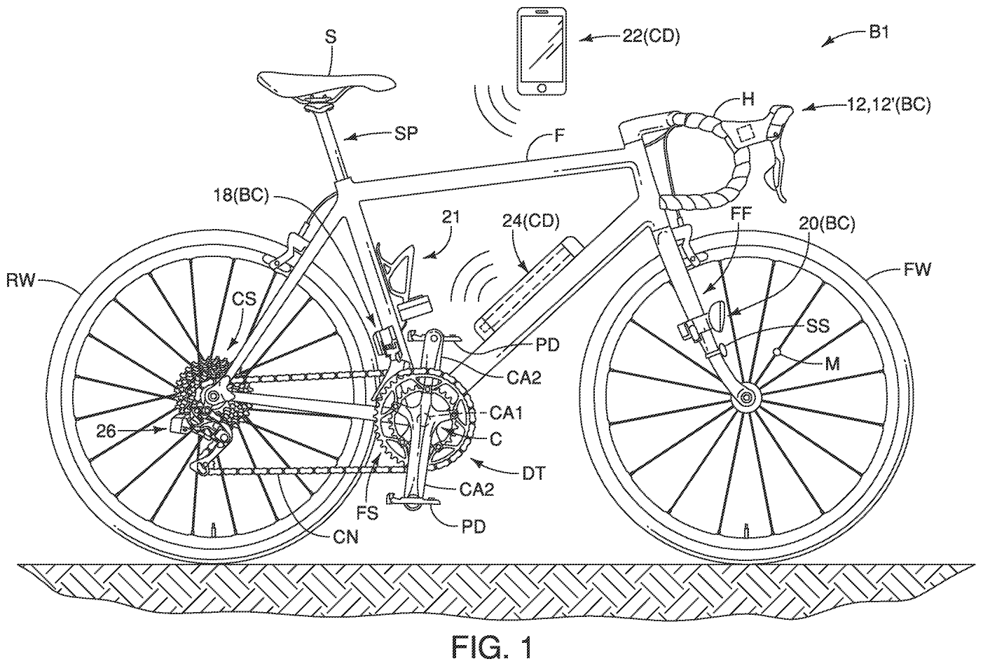

Referring initially to FIG. 1, a first bicycle B1 is illustrated that is equipped with a non-contact charging system 10 in accordance with one illustrated embodiment. The bicycle B1 is illustrated as a road bike. However, the non-contact charging system 10 can be applied to any other type of bicycles such as, for example, a mountain bike, a cyclocross bicycle, a gravel bike, a city bike, a cargo bike, and a recumbent bike. For example, a second bicycle B2 is illustrated as an electric assist bike that is equipped with the non-contact charging system 10 Basically, for each of the first bicycle B1 and the second bicycle B2, the non-contact charging system 10 comprises a bicycle component BC, and a non-contact charging device CD. For the sake of brevity, the common components or parts of the first bicycle B1 and the second bicycle B2 will be given the same reference symbol.

In the non-contact charging system 10, the bicycle component BC is provided other than a rear derailleur and a drive unit. In the illustrated embodiment, the bicycle component BC is at least one of an operating device 12 or 12′, an adjustable seatpost 14, an adjustable suspension 16, an adjustable front derailleur 18, a lamp 20, and an object holder 21. The operating device 12 or 12′, the adjustable seatpost 14, the adjustable suspension 16, the adjustable front derailleur 18, the lamp 20, and the object holder 21 can be provided to either the first bicycle B1 and the second bicycle B2. Thus, the term “bicycle component BC” as used herein generically refers to all of the bicycle components of the first bicycle B1 and the second bicycle B2 that are a part of the non-contact charging system 10, including but not limited to the operating device 12, the operating device 12′, the adjustable seatpost 14, the adjustable suspension 16, the adjustable front derailleur 18, the lamp 20, and the object holder 21. The components or parts of the first bicycle B1 and the second bicycle B2 that are a part of the non-contact charging system 10 will not be referred to as “bicycle component BC”.

The non-contact charging device CD can be mounted on the bicycle or can be a mobile device that is carried by a user. For example, as shown in FIG. 1, the non-contact charging device CD includes at least one of an external non-contact charging device 22 that can be carried by a user (e.g., a rider) and a battery unit 24 that is mounted to each of the first bicycle B1 and the second bicycle B2. Thus, the term “non-contact charging device CD” as used herein generically refers to all of the non-contact charging devices including but not limited to the external non-contact charging device 22 and the battery unit 24 illustrated in FIG. 1.

As shown in FIG. 1, the first bicycle B1 includes a frame F that is supported by a rear wheel RW and a front wheel FW. A front suspension fork FF is pivotally coupled at its upper end to the frame F, and rotatably supports the front wheel FW at its lower end. The bicycle B1 further includes a handlebar H mounted to the upper end of the front fork FF for steering the front wheel FW. The rear wheel RW is rotatably mounted to a rear end of the frame F. The seatpost SP is mounted to a seat tube of the frame F in a conventional manner and supports a bicycle seat or saddle S in any suitable manner.

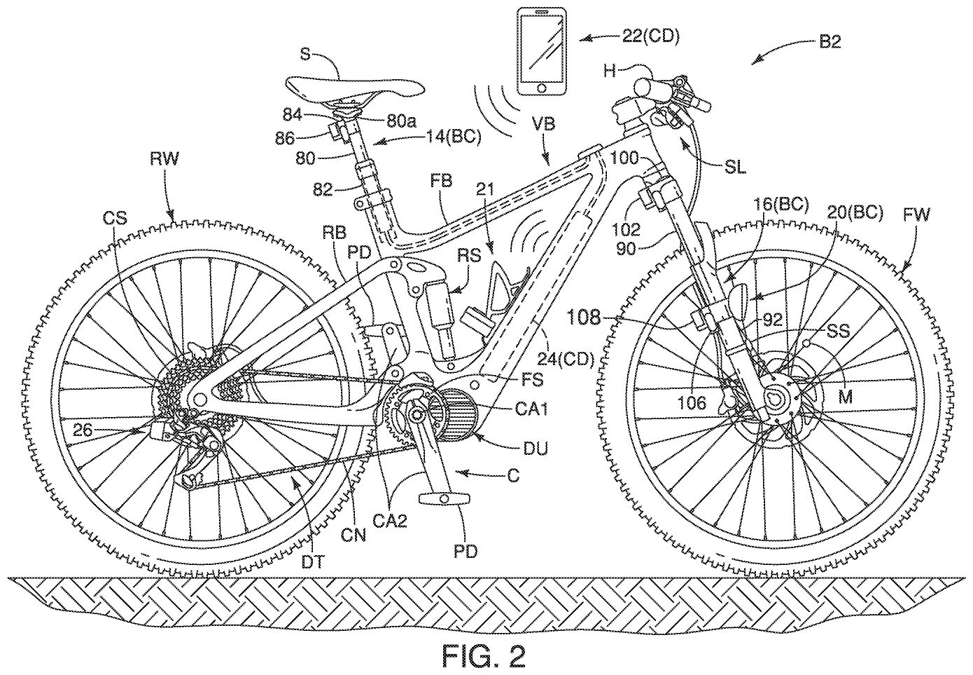

In contrast, as seen in FIG. 2, the second bicycle B2 includes a vehicle body VB that is supported by a rear wheel RW and a front wheel FW. The vehicle body VB basically includes a front frame body FB and a rear frame body RB (a swing arm). The vehicle body VB is also provided with a handlebar H. Here, the adjustable suspension 16 is pivotally coupled at its upper end to the front frame body FB, and rotatably supports the front wheel FW at its lower end. The rear frame body RB is swingably mounted to a rear section of the front frame body FB such that the rear frame body RB can pivot with respect to the front frame body FB. The rear wheel RW is mounted to a rear end of the rear frame body RB. A rear shock absorber RS is operatively disposed between the front frame body FB and rear frame body RB. The rear shock absorber RS is provided between the front frame body FB and the rear frame body RB to control the movement of the rear frame body RB with respect to the front frame body FB. Namely, the rear shock absorber RS absorbs shock transmitted from the rear wheel RW.

Here, the second bicycle B2 includes the adjustable seatpost 14 is mounted to a seat tube of the front frame body FB in a conventional manner and supports the bicycle seat or saddle S in any suitable manner. Also, here, the adjustable suspension 16 is pivotally mounted to a head tube of the front frame body FB. The handlebar H is mounted to an upper end of the adjustable suspension 16. The adjustable suspension 16 absorbs shock transmitted from the front wheel FW. The adjustable suspension 16 is an electrically adjustable suspension. For example, the stiffness and/or stoke length of the adjustable suspension 16 can be adjusted. While the rear shock absorber RS is not illustrated as an electrically adjustable suspension, it will be apparent from this disclosure that the rear shock absorber RS can be an adjustable suspension that is equipped as one of the bicycle component BC of the non-contact charging system 10.

Each of the first bicycle B1 and the second bicycle B2 further includes a drivetrain DT. Here, for example, the drivetrain DT is a chain-drive type that includes a crank C, at least one front sprocket FS, a plurality of rear sprockets CS and a chain CN. In the case of the first bicycle B1, the drivetrain DT has a plurality of the front sprocket FS. Also, in the case of the first bicycle B1, the adjustable front derailleur 18 is provided to the frame F. The adjustable front derailleur 18 is configured to the chain CN between the front sprockets FS in response to either an automatic shift signal from a cycle computer, or a user inputted shift signal from the operating device 12 or 12′. Each of the first bicycle B1 and the second bicycle B2 further includes a rear derailleur 26 (i.e., a bicycle component) that is configured to shift the chain CN between the rear sprockets CS in response to either an automatic shift signal from the cycle computer, or a user inputted shift signal from the operating device 12 or 12′ in the case of the first bicycle B1, or a user inputted shift signal from an operating device SL in the case of the second bicycle B2. The crank C includes a crank axle CA1 and a pair of crank arms CA2. The crank axle CA1 is rotatably supported to the front frame body FB via the electric assist unit E. The crank arms CA2 are provided on opposite ends of the crank axle CAL A pedal PD is rotatably coupled to the distal end of each of the crank arms CA2. While the drivetrain DT is illustrated as a chain-drive type of drivetrain, the drivetrain DT can be selected from any type of drivetrain, and can be a belt-drive type or a shaft-drive type.

The front sprocket(s) FS is provided on the crank C to rotate integrally with the crank axle CAL The rear sprockets CS are provided on a hub of the rear wheel RW. The chain CN runs around the front sprocket(s) FS and the rear sprockets CS. A human driving force is applied to the pedals PD by a rider such that the driving force is transmitted via the front sprocket(s) FS, the chain CN and the rear sprockets CS to the rear wheel RW.

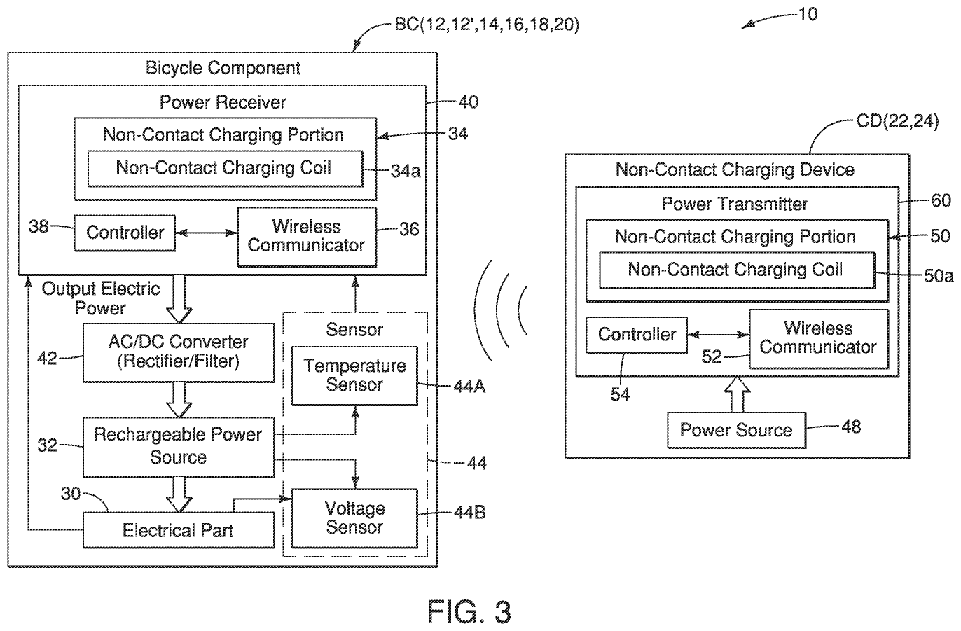

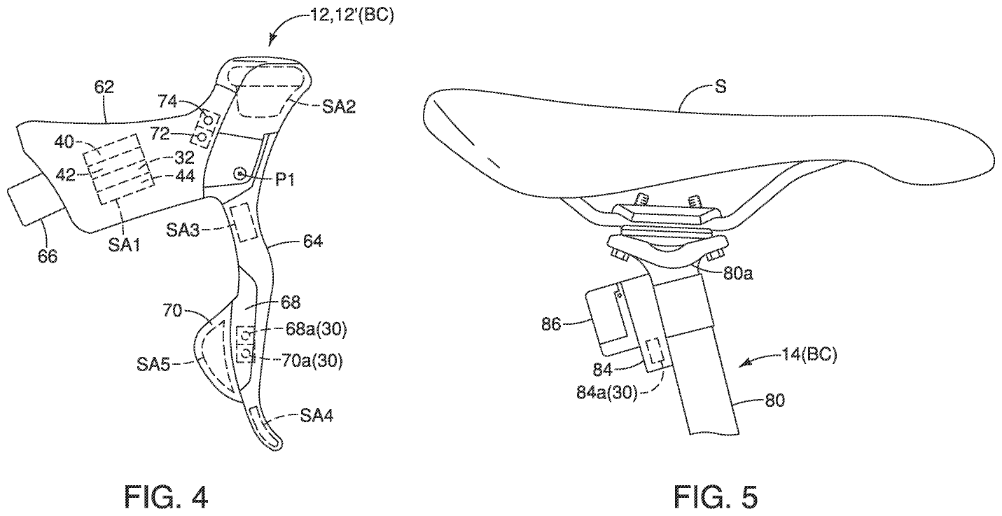

Referring now to FIG. 3, the non-contact charging system 10 will now be discussed in more detail. As mentioned above, basically, in each of the first bicycle B1 and the second bicycle B2, the non-contact charging system 10 comprises at least one of the bicycle components BC (e.g., at least one of the operating devices 12, 12′, the adjustable seatpost 14, the adjustable suspension 16, the adjustable front derailleur 18, the lamp 20, and the object holder 21) other than a rear derailleur and a drive unit, and at least one of the non-contact charging device CD (e.g., at least one of the external non-contact charging device 22 and the battery unit 24). Herein, each of the bicycle components BC (12, 12′, 14, 16, 18, 20, 21, 26) includes a basic configuration that is diagrammatically illustrated in the block diagram of FIG. 3. derailleur 18, the lamp 20, and the object holder 21

In particular, each of the bicycle components BC (12, 12′, 14, 16, 18, 20, 21, 26) comprises an electrical part 30, a rechargeable power source 32 and a non-contact charging portion 34. Depending on the bicycle component BC, the electrical part 30 can be an electric actuator, an electric motor, an electrical switch, an electronic controller, a light emitting element or any other part that uses electric power. The rechargeable power source 32 is electrically connected to the electrical part 30. In this way, the rechargeable power source 32 is configured to supply electric power to the electrical part 30. As the electrical part 30 is operated, electric power of the rechargeable power source 32 is depleted. Thus, the rechargeable power source 32 needs to be recharged over a period of time in which the electrical part 30 is operated. Thus, the non-contact charging portion 34 is electrically connected to the rechargeable power source 32 such that the rechargeable power source 32 receives electric power from the non-contact charging portion 34.

Here, each of the bicycle components BC (12, 12′, 14, 16, 18, 20, 21, 26) further comprises a wireless communicator 36 that is configured to communicate with the non-contact charging devices CD (22, 24). Thus, each of the bicycle components BC wirelessly communicate with the non-contact charging devices CD (22, 24) using the wireless communicator 36. The wireless communicator 36 of each of the bicycle components BC is also configured to wireless communicate with other sensors and/or other ones of the bicycle components BC. For example, each of the wireless communicators 36 is configured to wireless communicate a forward speed sensor SS. The forward speed sensor SS is mounted to the adjustable suspension 16. The forward speed sensor SS is configured to detect a magnet M that is mounted to a spoke of the front wheel FW. In this way, the wireless communicators 36 can receive a signal indicative of the bicycling traveling condition. It will be apparent from this disclosure that the wireless communicators 36 can receive other signals from other types of sensors or component that are indicative of the bicycling traveling condition. Moreover, depending on the bicycle component BC, the wireless communicators 36 can receive control signals and/or other data for aiding in the operating functions of the bicycle component BC.

The wireless communicator 36 is a hardware device capable of wirelessly transmitting a communication signal. The term “wireless communicator” as used herein includes a receiver, a transmitter, a transceiver, a transmitter-receiver, and contemplates any device or devices, separate or combined, capable of transmitting and/or receiving wireless communication signals. The wireless communication signals can be radio frequency (RF) signals, ultra-wide band communication signals, ANT+ communications, or Bluetooth® communications or any other type of signal suitable for short range wireless communications as understood in the bicycle field. Here, the wireless communicator 36 can be either a one-way wireless communicator or a two-way wireless communicator depending on the charging protocol. Preferably, the wireless communicator 36 is a two-way wireless communicator in that information is preferably exchanged between the wireless communicator 36 and the non-contact charging devices CD (22, 24) such as connection, charging and discharging status.

Also, in the illustrated embodiment, each of the bicycle components BC (12, 12′, 14, 16, 18, 20, 21, 26) further comprises a controller 38. The term “controller” as used herein refers to hardware that executes a software program, and does not include a human. The controller 38 is preferably an electronic controller that includes a Central Processing Unit (CPU) or a Micro-Processing Unit (MPU). Preferably, the controller 38 includes one or more processors and one or more storage devices. The memory device stores programs used by the controller 38. The memory device is any computer storage device or any computer readable medium with the sole exception of a transitory propagating signal. For example, the memory device can be nonvolatile memory and volatile memory, and can includes a ROM (Read Only Memory) device, a RAM (Random Access Memory) device, a hard disk, a flash drive, etc.

In FIG. 3, the non-contact charging portion 34, the wireless communicator 36 and the controller 38 form a power receiver 40 that is configured to receive electric power from the non-contact charging devices CD (22, 24). The non-contact charging portion 34, the wireless communicator 36 and the controller 38 are illustrated as separate elements in FIG. 3. However, those skill in the bicycle will recognize from this disclosure that one or more of the non-contact charging portion 34, the wireless communicator 36 and the controller 38 can integrated together completing the activities or functions described herein. For example, in the illustrated embodiment, the wireless communicator 36 and the controller 38 are provided on a common circuit board containing any number of integrated circuit or circuits for completing the activities described herein. Also, while the controller 38 is illustrated as being a single unit located on the circuit board of the power receiver 40, the bicycle components BC (12, 12′, 14, 16, 18, 20, 21, 26) are not limited to this configuration. Rather, the controller 38 can be a plurality of controllers that are provided at various locations.

As explained later, the controller 38 is further configured to restrict an operating function of the electrical part 30 upon determining a parameter of the rechargeable power source 32 is outside of a permissible range. The controller 38 is further configured to maintain the operating function of the electrical part 30 upon determining the parameter of the rechargeable power source 32 is inside of the permissible range.

The non-contact charging portion 34 is configured to wirelessly receive external electric power and to supply the external electric power to the rechargeable power source 32. The non-contact charging portion 34 includes at least a non-contact charging coil 34a. The at least non-contact charging coil 34a can include Near-Field Communication (NFC) for use in in those situations in which the non-contact charging device CD (e.g., the external non-contact charging device 22) can be placed within a few centimeters (about 4 cm or less) of the non-contact charging coil 34a of the bicycle component BC. For example, the rider could use the external non-contact charging device 22 to charge and communicate with one of the operating device 12 or 12′ by holding the external non-contact charging device 22 next to the operating device 12 or 12. The term “NFC” as used herein refers to short-range wireless communication that achieves communication by electromagnetic induction using a frequency in the 13.56 MHz band. Further, non-contact charging transmits power by electromagnetic induction using a frequency in a band between approximately 100 kHz and 200 kHz.

On the other hand, the at least non-contact charging coil 34a can be configured to use magnetic resonance so that the non-contact charging devices CD (22, 24) can be one or two meters way from the bicycle components BC (12, 12′, 14, 16, 18, 20, 21, 26). When the non-contact charging coil 34a receive electric power via magnetic resonance, the wireless communicator 36 is used to communicate information to and from the non-contact charging devices CD (22, 24).

In the illustrated embodiment, each of the bicycle components BC (12, 12′, 14, 16, 18, 20, 21, 26) further comprises an AC/DC converter 42 that is disposed between the non-contact charging portion 34 and the rechargeable power source 32. The AC/DC converter 42 converts the alternating current outputted by the non-contact charging portion 34 to direct current that is received by the rechargeable power source 32. In this way, the direct current outputted by the AC/DC converter 42 is used to recharge the rechargeable power source 32.

In the illustrated embodiment, each of the bicycle components BC (12, 12′, 14, 16, 18, 20, 21, 26) further comprises a sensor 44 that is configured to detect information relating to a condition of the rechargeable power source 32. The sensor 44 is configured to communicate with the controller 38 of the power receiver 40. The sensor 44 can be configured to communicate with the controller 38 of the power receiver 40 by either wired communication or wireless communication. By employing the sensor 44, the recharging of the rechargeable power source 32 can be improved based on the condition of the rechargeable power source 32.

Here, the sensor 44 includes a temperature sensor 44A that configured to detect a temperature of the rechargeable power source 32. The temperature of the rechargeable power source 32 can be used to determine the electrical load on the rechargeable power source 32 and the condition of the rechargeable power source 32. The temperature sensor 44A is configured to communicate with the controller 38 of the power receiver 40. The temperature sensor 44A can be configured to communicate with the controller 38 of the power receiver 40 by either wired communication or wireless communication. By using the temperature sensor 44A to detect a temperature of the rechargeable power source 32, an electrical load of the rechargeable power source 32 can be determined.

In the illustrated embodiment, the sensor 44 includes a voltage sensor 44B that is configured to detect at least one of a voltage of the rechargeable power source 32 and a voltage supplied to the rechargeable power source 32. The voltage sensor 44B is configured to communicate with the controller 38 of the power receiver 40. The voltage sensor 44B can be configured to communicate with the controller 38 of the power receiver 40 by either wired communication or wireless communication. In this way, the controller 38 can monitor the recharging of the rechargeable power source 32. The controller 38 is further configured to monitor at least one of voltage of the rechargeable power source 32 and voltage of the electrical part after a prescribed period of time elapsing from a start of the charging. Also, the controller 38 is configured to adjust at least one of a voltage supplied to the rechargeable power source 32 and a voltage supplied to the electrical part 30.

Now, the non-contact charging devices CD (22, 24) will be discussed in more detail. Each of the non-contact charging devices CD (22, 24) includes a power source 48. The power source 48 can be any type of device that can transmit electric power to the rechargeable power sources 32 of the bicycle components BC (12, 12′, 14, 16, 18, 20, 21, 26). For example, the power source 48 can include one or more a hydrogen powered fuel cell, a disposable battery, a rechargeable battery, a capacitor and an electric generator. In the illustrated embodiment, the battery unit 24 (CD) has one or more rechargeable batteries.

Each of the non-contact charging devices CD (22, 24) includes a non-contact charging portion 50 that is configured to wirelessly transmit electric power to the bicycle component BC. The non-contact charging portion 50 includes at least a non-contact charging coil 50a. In the case of the external non-contact charging device 22, the at least non-contact charging coil 50a can include Near-Field Communication (NFC) so that user can place the external non-contact charging device 22 within a few centimeters (about 4 cm or less) of the non-contact charging coil 34a of the bicycle component BC. In the case of the battery unit 24, the at least non-contact charging coil 50a is configured to use magnetic resonance which can transmit electric power up one or two meters. In this way, the rechargeable power sources 32 of the bicycle components BC (12, 12′, 14, 16, 18, 20, 21, 26) can be wirelessly charged while on the first bicycle B1 or the second bicycle B2 and while the first bicycle B1 or the second bicycle B2 is traveling. Preferably, the non-contact charging coil 50a of the external non-contact charging device 22 is also configured to use magnetic resonance which can transmit electric power up one or two meters. Preferably, the non-contact charging coils 50a of the non-contact charging devices CD (22, 24) are configured so that the wirelessly transmitted electric power can be aimed at the non-contact charging portions 34 of the bicycle components BC (12, 12′, 14, 16, 18, 20, 21, 26).

In the illustrated embodiment, each of the non-contact charging devices CD (22, 24) further includes a wireless communicator 52 for wirelessly communicating with the wireless communicators 36 of the bicycle components BC (12, 12′, 14, 16, 18, 20, 21, 26). The wireless communicator 52 is a hardware device capable of wirelessly transmitting a communication signal to the wireless communicators 36 of the bicycle components BC (12, 12′, 14, 16, 18, 20, 21, 26). The wireless communication signals can be radio frequency (RF) signals, ultra-wide band communication signals, ANT+ communications, or Bluetooth® communications or any other type of signal suitable for short range wireless communications as understood in the bicycle field. Here, the wireless communicator 52 can be either a one-way wireless communicator or a two-way wireless communicator depending on the charging protocol used with the wireless communicator 36. Preferably, the wireless communicator 52 is a two-way wireless communicator in that information is preferably exchanged between the wireless communicator 36 and the wireless communicator 52 such as connection, charging and discharging status.

Also, in the illustrated embodiment, each of the non-contact charging devices CD (22, 24) further comprises a controller 54. The controller 54 is preferably an electronic controller that includes a Central Processing Unit (CPU) or a Micro-Processing Unit (MPU). Preferably, the controller 54 includes one or more processors and one or more storage devices. The memory device stores programs used by the controller 54. The memory device is any computer storage device or any computer readable medium with the sole exception of a transitory propagating signal. For example, the memory device can be nonvolatile memory and volatile memory, and can includes a ROM (Read Only Memory) device, a RAM (Random Access Memory) device, a hard disk, a flash drive, etc.

In the illustrated embodiment, the non-contact charging portion 50, the wireless communicator 52 and the controller 54 form a power transmitter 60 that is configured to transmit electric power to the power receivers 40 of the bicycle components BC (12, 12′, 14, 16, 18, 20, 21, 26). The non-contact charging portion 50, the wireless communicator 52 and the controller 54 are illustrated as separate elements in FIG. 3. However, those skill in the bicycle will recognize from this disclosure that one or more of the non-contact charging portion 50, the wireless communicator 52 and the controller 54 can integrated together completing the activities or functions described herein. For example, in the illustrated embodiment, the non-contact charging portion 50, the wireless communicator 52 and the controller 54 are provided on a common circuit board containing any number of integrated circuit or circuits for completing the activities described herein.

Referring now to FIGS. 1, 3 and 5, the operating device 12 and the operating device 12′ of the first bicycle B1 will be discussed in more detail. The operating device 12 and the operating device 12′ are electrical devices that control one or more of the other bicycle components BC (18, 20, 26). For example, the operating device 12 is configured to wirelessly control the lamp 20 and the rear derailleur 26, while the operating device 12 can be configured to wirelessly control the adjustable front derailleur 18 and the lamp 20. Of course, it will be apparent from this disclosure that the bicycle components controlled by the operating device 12 and the operating device 12′ is not limited to this particular configuration. Also, the operating device 12 and the operating device 12′ also function as brake control devices in a conventional manner.

Here, the operating device 12 is mounted on the right side of the handlebar H, while the operating device 12′ is mounted on the left side of the handlebar H. The operating device 12 is a mirror image of the operating device 12′. Thus, the following description of the operating device 12 applies to the operating device 12′ unless otherwise specified.

The operating device 12 basically comprises a base member 62 and an operating lever 64. The operating lever 64 is movably coupled to the base member 62. In this embodiment, the operating lever 64 is pivotally coupled to the base member 62 about a pivot axis P1 to perform a braking operation. The operating device 12 further comprises a handlebar mounting clamp 66. The base member 62 is mounted to the handlebar H by the handlebar mounting clamp 66 in a conventional manner. Here, the base member 62 is provided with a first spatial area SA1 in which the rechargeable power source 32, the power receiver 40, the AC/DC converter 42 and the sensor 44 are located. However, one or more of the rechargeable power source 32, the power receiver 40, the AC/DC converter 42 and the sensor 44 can be located at other areas spatial areas of the operating device 12. For example, the pommel portion of the base member 62 can include a second spatial area SA2 for receiving one or more of the rechargeable power source 32, the power receiver 40, the AC/DC converter 42 and the sensor 44. Also, the operating lever 64 can include a third spatial area SA3 and/or a fourth spatial area SA4 for receiving one or more of the rechargeable power source 32, the power receiver 40, the AC/DC converter 42 and the sensor 44.

As mentioned above, the electrical part 30 is included in each of the bicycle components BC (12, 12′, 14, 16, 18, 20, 21, 26). In the case of the operating device 12, the electrical part 30 includes an electrical switch configured to output an electrical signal to operate an external device. More specifically, in the case of the operating device 12, the bicycle component BC further comprises an operating member 68 that is configured to activate an electrical switch 68a. Also, the operating device 12 further comprises an operating member 70 that is configured to activate an electrical switch 70a. The operating member 70 can be provided with a fifth spatial area SA5 for receiving one or more of the rechargeable power source 32, the power receiver 40, the AC/DC converter 42 and the sensor 44. Thus, in the case of the operating device 12, the electrical part 30 of the operating device 12 includes the electrical switch 68a and the electrical switch 70a. The rechargeable power source 32 is electrically connected to the electrical switch 68a and the electrical switch 70a to supply electrical power to the electrical switch 68a and the electrical switch 70a.

Here, one of the electrical switch 68a and the electrical switch 70a outputs an upshift signal to the rear derailleur 26, while the other one of the electrical switch 68a and the electrical switch 70a outputs a downshift signal to the rear derailleur 26. The upshift signal and the downshift signal are wireless communicated from the wireless communicator 36 (see FIG. 3) of the power receiver 40 to the wireless communicator 36 of the rear derailleur 26. Preferably, the wireless communicator 36 (see FIG. 3) of the power receiver 40 of the operating device 12 is a two-way wireless communicator that can both send and receive signals.

The operating member 68 and the operating member 70 are movably mounted to the operating lever 64, while the electrical switch 68a and the electrical switch 70a are fixed to the operating lever 64. Thus, here, pivotal movement of the operating member 68 relative to the operating lever 64 causes the operating member 68 to activate (depress) the electrical switch 68a to operate an external device. Similarly, pivotal movement of the operating member 70 relative to the operating lever 64 causes the operating member 70 to activate (depress) the electrical switch 70a to operate an external device. In the illustrated embodiment, the external device corresponds to the rear derailleur 26 that is operated in response to the activation of the electrical switch 68a and the electrical switch 70a.

Here, the operating device 12 further comprises an electrical switch 72 provided on the base member 62, and an electrical switch 74 provided on the base member 62. While the electrical switch 72 is illustrated as being integrated with the operating device 12, the electrical switch 72 not limited to the illustrated embodiment. The electrical switch 72 can be separate from the operating device 12 such as mounted to the handlebar H. Here, the user can depress the electrical switch 72 and/or electrical switch 74 to output an electrical signal to operate an external device such as the lamp 20 and/or some other electrically controlled part of the first bicycle B1. The electrical part 30 of the operating device 12 includes the electrical switch 72 and the electrical switch 74. In the case where the controller 38 of the operating device 12 determines a parameter (e.g., temperature) of the rechargeable power source 32 of the operating device 12 is outside of the permissible range, then the controller 38 of the operating device 12 can restrict the operating function of one or more of the electrical switches 68a, 70a, 72 and 74 (the electrical part 30) so that only certain switches are operational and/or certain functions of the switches are suspended.

In the case of the operating device 12′, which has the same physical structure as the operating device 12, the electrical switch 68a and the electrical switch 70a are used to control the adjustable front derailleur 18 (BC). In other words, in the case of the operating device 12′, one of the electrical switch 68a and the electrical switch 70a outputs an upshift signal to the adjustable front derailleur 18, while the other one of the electrical switch 68a and the electrical switch 70a outputs a downshift signal to the adjustable front derailleur 18. The upshift signal and the downshift signal are wireless communicated from the wireless communicator 36 (see FIG. 3) of the power receiver 40 to the wireless communicator 36 of the adjustable front derailleur 18. Preferably, the wireless communicator 36 (see FIG. 2) of the power receiver 40 of the operating device 12 is a two-way wireless communicator that can both send and receive signals.

Referring now to FIGS. 1, 3 and 5, the adjustable seatpost 14 of the second bicycle B2 will be discussed in more detail. Here, the adjustable seatpost 14 is a height adjustable seatpost. The adjustable seatpost 14 basically includes a first (inner or upper) tubular member 80, a second (outer or lower) tubular member 82 and a seat mount 82. The first tubular member 80 and the second tubular member 82 are telescopically arranged to move between a retracted position and an extended position. The adjustable seatpost 14 further includes an electric drive mechanism 84 provided to the seat mount 82 and operatively connected between the first tubular member 80 and the second tubular member 82 to adjust the relative position between the first tubular member 80 and the second tubular member 82. The particular construction of the electric drive mechanism 84 can be any drive mechanism that can be used to telescopically move the first tubular member 80 relative to the second tubular member 82.

Here, in the adjustable seatpost 14, the electrical part 30 is an electric motor or an electric actuator 84a of the electric drive mechanism 84. Also, in the adjustable seatpost 14, the power receiver 40 and the AC/DC converter 42 are housed by the electric drive mechanism 84. The adjustable seatpost 14 further includes a battery unit 86 that contains the rechargeable power source 32. Here, the battery unit 86 is removably mounted to the housing of the electric drive mechanism 84. In the case where the controller 38 of the adjustable seatpost 14 determines a parameter (e.g., temperature) of the rechargeable power source 32 of the adjustable seatpost 14 is outside of the permissible range, then the controller 38 of the adjustable seatpost 14 can restrict the operating function of the electric motor or actuator 84a (the electrical part 30) of the electric drive mechanism 84 so that the adjustable seatpost 14 can only be lower or set one a predetermined position.

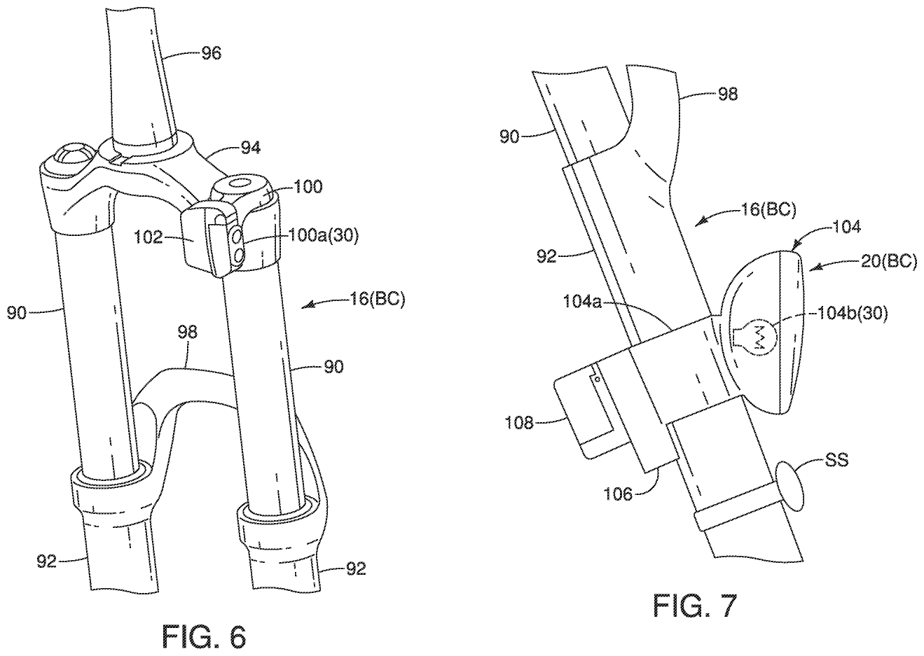

Referring now to FIGS. 1, 3 and 6, the adjustable suspension 16 of the second bicycle B2 will be discussed in more detail. The adjustable suspension 16 is a front suspension fork that basically includes a pair of first (inner or upper) tubular members 90, a pair of second (outer or lower) tubular members 92, a crown 94, and a steerer tube 96. The first tubular members 90 and the second tubular members 92 are telescopically arranged to absorb shocks in a conventional manner. The first tubular members 90 and the second tubular members 92 for conventional air shocks with a hydraulic dampening mechanism. Here, the upper ends of the first tubular members 90 are connected together by a crown 94. The upper ends of the second tubular members 92 are integrally connected by a brace 98. The steerer tube 96 is fixed to the crown 94 so that the adjustable suspension 16 can be pivoted relative to the frame F by the handlebar H.

The adjustable suspension 16 further includes an electric adjustment mechanism 100 provided to one of the first tubular members 90 to adjust or change the stiffness/softness and/or stoke length of the adjustable suspension 16. Here, in the adjustable suspension 16, the electrical part 30 is an electric motor or an electric actuator 100a of the electric adjustment mechanism 100. Also, in the adjustable suspension 16, the power receiver 40 and the AC/DC converter 42 are housed by the electric adjustment mechanism 100. The adjustable suspension 16 further includes a battery unit 102 that contains the rechargeable power source 32. Here, the battery unit 102 is removably mounted to the housing of the electric adjustment mechanism 100. In the case where the controller 38 of the adjustable suspension 16 determines a parameter (e.g., temperature) of the rechargeable power source 32 of the adjustable suspension 16 is outside of the permissible range, then the controller 38 of the adjustable suspension 16 can restrict the operating function of the electric motor or actuator 100a (the electrical part 30) of the electric adjustment mechanism 100 so that the adjustable suspension 16 can only one function (stiffness/softness or stoke length) can be changed.

Referring now to FIGS. 1, 3 and 7, the lamp 20 provided to each of the first bicycle B1 and the second bicycle B2 will be discussed in more detail. The lamp 20 basically includes a lamp housing 104 having a mounting clamp 104a and an electrical unit 106 electrical connected to a light emitting element 104b. Here, in the lamp 20, the electrical part 30 is the light emitting element 104b that is disposed in the lamp housing 104. Also, in the lamp 20, the power receiver 40 and the AC/DC converter 42 are housed by the electrical unit 106. The lamp 20 further includes a battery unit 108 that contains the rechargeable power source 32. Here, the battery unit 102 is removably mounted to the housing of the electrical unit 106. In the case where the controller 38 of the lamp 20 determines a parameter (e.g., temperature) of the rechargeable power source 32 is outside of the permissible range, then the controller 38 of the lamp 20 can restrict the operating function of the light emitting element 104b (the electrical part 30) so that the lamp 20 turns off or dims the output of the light emitting element.

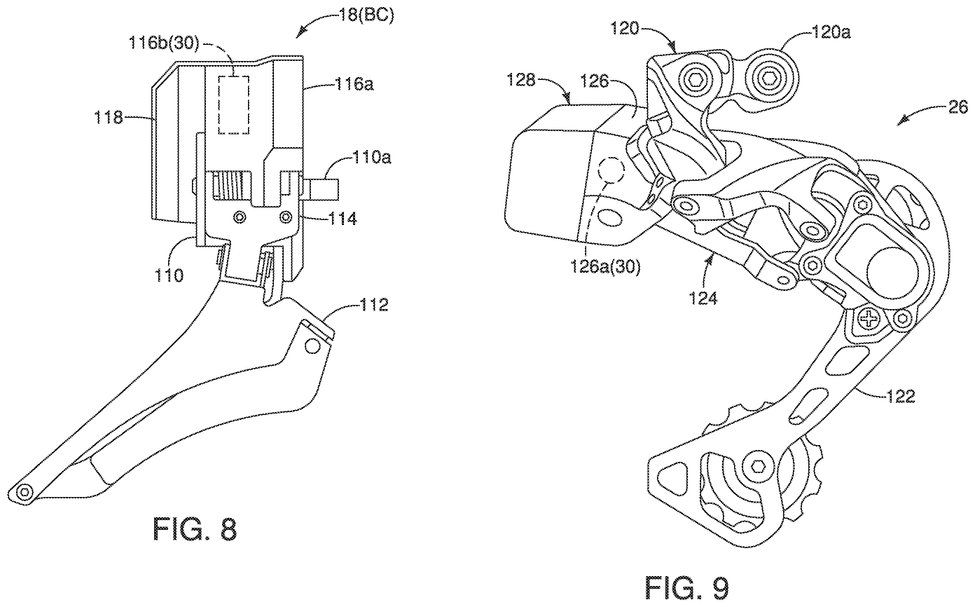

Referring now to FIGS. 1, 3 and 8, the adjustable front derailleur 18 of the first bicycle B1 will be discussed in more detail. The adjustable front derailleur 18 basically includes a base member 110, a chain guide 112 and a linkage 114. The base member 110 includes a frame mount 110a for mounting the adjustable front derailleur 18 to the frame F. The adjustable front derailleur 18 further includes an electric motor unit 116 provided on the base member 110 operatively coupled to the linkage 114 for moving the chain guide 112 between at least a two sprocket positions.

Here, in the front derailleur 18, the electrical part 30 is an electric motor or an electric actuator 116b of the electric motor unit 116. Also, in the adjustable front derailleur 18, the power receiver 40 and the AC/DC converter 42 are housed by the electric motor unit 116. The adjustable front derailleur 18 further includes a battery unit 118 that contains the rechargeable power source 32. Here, the battery unit 118 is removably mounted to the housing of the electric motor unit 116. In the case where the controller 38 of the adjustable front derailleur 18 determines a parameter (e.g., temperature) of the rechargeable power source 32 of the adjustable front derailleur 18 is outside of the permissible range, then the controller 38 of the adjustable front derailleur 18 can restrict the operating function of the electric motor or actuator 116b (the electrical part 30) of the electric motor unit 116 so that the adjustable front derailleur 18 can only downshift, only upshift, or move to a predetermined shift setting.

Referring now to FIGS. 1, 3 and 9, the rear derailleur 26 provided to each of the first bicycle B1 and the second bicycle B2 will be discussed in more detail. The rear derailleur 26 basically includes a base member 120, a chain guide 122 and a linkage 124. The base member 120 includes a frame mount 120a for mounting the rear derailleur 26 to the frame F. The rear derailleur 26 further includes an electric motor unit 126 provided on the base member 120 operatively coupled to the linkage 124 for moving the chain guide 122 between at least a plurality of sprocket positions.

Here, in the rear derailleur 26, the electrical part 30 is an electric motor or an electric actuator 126a of the electric motor unit 126. Also, in the rear derailleur 26, the power receiver 40 and the AC/DC converter 42 are housed by the electric motor unit 116. The rear derailleur 26 further includes a battery unit 128 that contains the rechargeable power source 32. Here, the battery unit 128 is removably mounted to the housing of the electric motor unit 126. In the case where the controller 38 of the rear derailleur 26 determines a parameter (e.g., temperature) of the rechargeable power source 32 of the rear derailleur 26 is outside of the permissible range, then the controller 38 of the rear derailleur 26 can restrict the operating function of the electric motor or actuator 126a (the electrical part 30) of the electric motor unit 126 (the electrical part 30) so that the rear derailleur 26 can only downshift, only upshift, or move to a predetermined shift setting.

Referring now to FIGS. 1 to 3 and 10, the object holder 21 provided to each of the first bicycle B1 and the second bicycle B2 will be discussed in more detail. Here, the object holder 21 is configured to hold a bicycle water bottle WB. However, the object holder 21 is not limited to a bicycle water bottle. Rather, the object holder 21 can be other types of holders such as an air pump holder. The bicycle component BC (e.g., the object holder 21) basically comprises a base member 130 and a power receiver 131. The power receiver 131 has the same construction the power receiver 40 as seen in FIG. 3, except that the power receiver 131 has been adapted to be part of the object holder 21.

The base member 130 is configured to be mounted to a bicycle (e.g., the first bicycle B1 or the second bicycle B2). In particular, the base member 130 includes at least one mounting portion 132 that is mounted to a braze-on mount of the first bicycle B1 or the second bicycle B2 using at least one fastener. Here, the base member 130 includes a pair of mounting portions 132 that are mounted to a pair of braze-on mounts of the first bicycle B1 or the second bicycle B2 using a pair of fasteners. The base member 130 includes a holding portion 134 that is configured to removably hold at least one object. Here, the holding portion 134 is configured to hold the water bottle WB such as a reusable water bottle or a disposable water bottle. The holding portion 134 can also be called a holding portion, a cage, a receptacle, or a clip depending on the structure of the holding portion 134. Thus, the object holder 21 includes a water bottle cage in the illustrated embodiment.

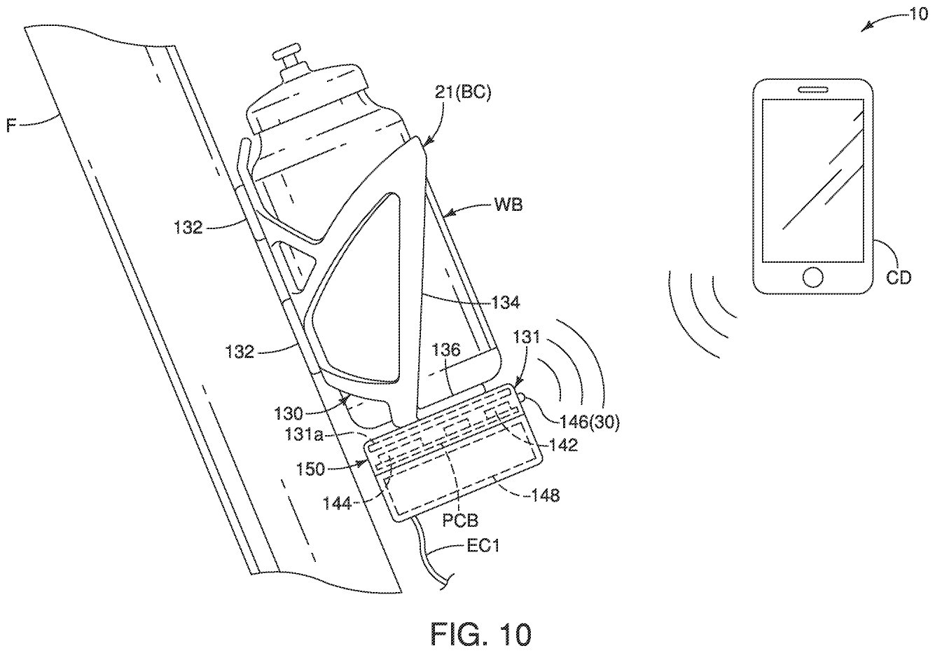

As seen in FIG. 10, the power receiver 131 is mounted to the base member 132. In particular, the base member 132 includes a support portion 136 configured to support the power receiver 131. Basically, as seen in FIG. 3, the power receiver 141 includes the non-contact charging portion 141a that is configured to wirelessly receive external electric power and to supply the external electric power to at least one of a rechargeable power source and an electrical component. Also, the power receiver 141 includes a wireless communicator 142 and a controller 144 similar to the other bicycle components BC that are discussed above. The power receiver 141 has a circuit board PCB in which the wireless communicator 142 and the controller 144 are provided on. In this embodiment, the object holder 21 includes an electrical part 146 and a rechargeable power source 148. Preferably, the circuit board PCB is provided with an AC/DC converter such as the AC/DC converter 42 shown in FIG. 3 and discussed above. Preferably, the circuit board PCB is provided with a sensor such as the sensor converter 44 shown in FIG. 3 and discussed above. Thus, the circuitry of the circuit board PCB for controlling the electrical part 146 (the electrical part 30) and the rechargeable power source 148 is the same as circuitry of FIG. 3 as discussed above with respect to the other bicycle components BC. Here, in the object holder 21, the electrical part 146 can be, for example, an indicator light, a decorative light, a water bottle heating element, etc. As seen in FIG. 10, the electrical part 146 is a light emitting element for indicating a function of the object holder 21 such as a level of charge. The rechargeable power source 148 can be electrically connected to another one of the bicycle components BC via an electrical cord EC1. In this way, the external electric power can be provided to another one of the bicycle components BC via the rechargeable power source 148.

In the case where the controller 144 of the object holder 21 determines a parameter (e.g., temperature) of the rechargeable power source 148 is outside of the permissible range, then the controller 148 of the object holder 21 can restrict the operating function the electrical part 146. For example, if the electrical part 30 of the object holder 21 is a light emitting element, then the controller 144 can turn off or dims the output of the light emitting element. Also, for example, if the electrical part 146 of the object holder 21 is a water bottle heating element, then the controller 144 can turn off or reduce the output of the water bottle heating element.

The power receiver 141 has a housing 150 that accommodates the non-contact charging portion 131a and the circuit board PCB which includes the wireless communicator 142, the controller 144, the AC/DC converter and the sensor. Here, the rechargeable power source 148 is also disposed in the housing 150 of the power receiver 141. In this embodiment, the rechargeable power source 148 is disposed in the power receiver 141. However, the rechargeable power source 148 can be remotely located from the power receiver 141 as needed and/or desired. The housing 150 is preferably a waterproof structure. Thus, the power receiver 141 includes a waterproof structure accommodating the non-contact charging portion. Here, the housing 150 is a two piece structure in which the two parts are screwed together with a rubber seal disposed between the two parts. In this way, the housing 150 can be open and reclosed to replace the rechargeable power source 148 or to service the parts of the power receiver 141. Alternatively, the housing 150 can a one-piece member or two parts that are permanently coupled together.

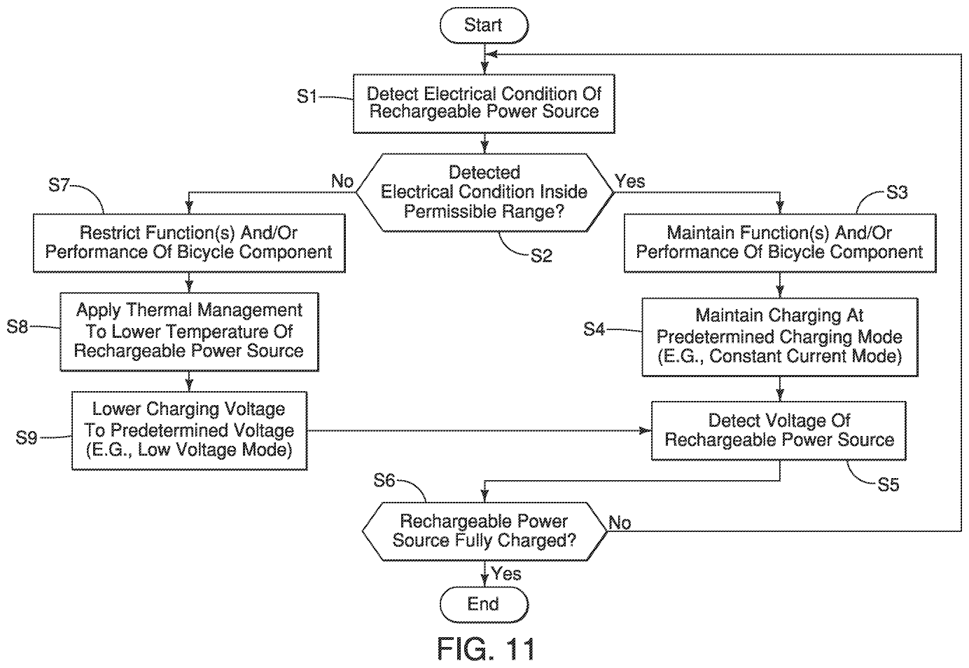

Referring now to FIG. 11, the rechargeable power sources 32 of the bicycle components BC (12, 12′, 14, 16, 18, 20, 21, 26) are automatically recharged by one of the non-contact charging devices CD (22, 24) while the first bicycle B1 or the second bicycle B2 is travelling. Thus, in accordance with this disclosure, a non-contact charging method is provided for charging the rechargeable power source of a bicycle component. In particular, one exemplary non-contact charging method or process for recharging the rechargeable power source 32 for each of the bicycle components BC (12, 12′, 14, 16, 18, 20, 21, 26) will now be described with reference to FIG. 11. The exemplary non-contact charging method or process of FIG. 11 is executed by the controller 38 at a predetermined time interval and/or each time the electrical part 30 is operated. Once the predetermined time interval has elapsed and/or each time the electrical part 30 is operated, the controller 38 starts the non-contact charging process by communicating with the bicycle component BC and the non-contact charging device CD. Thus, the non-contact charging method comprises starting wireless communication between the bicycle component BC and the non-contact charging device CD. This wireless communication is a form of speech to express any information of the bicycle component BC to indicate a need for the BC to be automatically charged, or the bicycle component BC being placed near the non-contact charging device CD when a user decide to charge the bicycle component BC. Once wireless communication exists between the bicycle component BC and the non-contact charging device CD, the contact charging method proceeds to step S1 in the flowchart of FIG. 11.

In step S1, the controller 38 detects a condition of the rechargeable power source 32. In other words, the non-contact charging method comprises detecting a condition of the rechargeable power source 32. The condition of the rechargeable power source 32 can be detected in a variety of ways. In any case, the detected condition of the rechargeable power source 32 is indicative of a condition of the rechargeable power source 32 relating to at least one of a state of charge, a charge current, an internal resistance, a temperature, a voltage, a power source age, an electrical load, and any other parameter relating to chargeability. In the illustrated embodiment, the temperature of the rechargeable power source 32 is used as the condition the rechargeable power source 32 that is being detected. Thus, the non-contact charging method further comprises detecting a temperature of the rechargeable power source 32 as the condition. After detecting the condition (e.g., the temperature and/or the voltage) of the rechargeable power source 32, the controller 38 proceeds to step S2.

In step S2, the controller 38 confirms a parameter (e.g., the temperature and/or the voltage) of the rechargeable power source 32 based on a result of the condition that was detected. In other words, the non-contact charging method comprises confirming a parameter of the rechargeable power source 32 based on a result of the condition that was detected. In particular, the controller 38 determines whether the detected condition or parameter of the rechargeable power source 32 is inside a permissible range. For example, the controller 38 can have prestored in memory charging tables and/or charging maps charging that control the charging based on one or more of a plurality of parameters such as a state of charge, a charge current, an internal resistance, a temperature, a voltage, a power source age, an electrical load, and any other parameter relating to chargeability.

Preferably, the parameter is an electrical load or an electrical condition such as the remaining current power of the rechargeable power source 32, the temperature/heat of the rechargeable power source 32 or the electrical device 30. The parameter (the electrical load or the electrical condition) is being detected by using one or more sensors, and the information detected by the sensor(s) will be process by the controller 38 to check whether the (the electrical load or the electrical condition) is below or above the permissible range. For example, the electrical load of the rechargeable power source 32 can be determined from the temperature detected by the temperature sensor 44A and the electrical condition (remaining electric power) of the rechargeable power source 32 can be determined from the voltage detected by the of the rechargeable power source 32 can be determined from the temperature detected by the temperature sensor 44A sensor 44B. If the temperature and/or remaining power is below the permissible range, the controller 38 will control the non-contact charging portion 34 to maintain the current charging level and/or phase. If the temperature and/or the remaining power is above the permissible range, the controller 38 will control the non-contact charging portion 34 to adjust the charging level, for example to lower voltage and/or longer charging time.

Upon determining the parameter is indicative that the state of charge of the rechargeable power source 32 is suitable for operating the bicycle component BC without any restrictions (i.e., normal operation of the bicycle component BC is permissible), the controller 38 proceeds to step S3.

In step S3, the controller 38 permits control of the bicycle component BC so that the bicycle component BC can be operated without any restrictions (i.e., normal operation of the bicycle component BC is permissible). In other words, the non-contact charging method further comprises maintaining the operating function of the bicycle component BC upon determining the parameter of the rechargeable power source 32 is inside of the permissible range. Then, the controller 38 proceeds to step S4.

In step S4, the controller 38 starts or maintains a predetermined charging mode that is suitable for the detected condition of the rechargeable power source 32. In other words, the non-contact charging method comprises charging the rechargeable power source 32 of the bicycle component BC. Here, the predetermined charging mode can be a preferred charging mode such as a constant current mode of charging. The preferred charging mode is used since the detected condition of the rechargeable power source 32 is indicative of a condition in which the bicycle component BC can be operated without restrictions and the rechargeable power source 32 can be recharged optimally. Also, in the illustrated embodiment, as mentioned above, the non-contact charging portion 34 outputs outputted. Thus, in the illustrated embodiment, the AC/DC converter 42 is provided between the non-contact charging portion 34 and the rechargeable power source 32 to convert the alternating current outputted by the non-contact charging portion 34 to direct current that is received by the rechargeable power source 32. As a result, in the illustrated embodiment, the non-contact charging method further comprises converting alternating current from the non-contact charging portion 34 to direct current that is supplied to the rechargeable power source 32. Then, the controller 38 proceeds to step S5.

In step S5, the controller 38 monitors the voltage of the rechargeable power source 32 using the voltage sensor 44B, which either directly detects the voltage of the rechargeable power source 32 or indirectly detects the voltage of the rechargeable power source 32 by detecting the voltage of the electrical part 30. Thus, the non-contact charging method further comprises monitoring the voltage of the rechargeable power source 32 after a prescribed period of time elapsing from a start of the charging. Then, the controller 38 proceeds to step S6.

In step S6, the controller 38 determines whether the rechargeable power source 32 is fully charged (i.e., charged to a prescribed level in which charging is to be stopped). As used herein, the term “fully charged” does not require the rechargeable power source 32 to be charged to its maximum capacity. Rather, the term “fully charged” can include a charge capacity that is less than the maximum capacity. If the controller 38 determines the rechargeable power source 32 has reached the desired fully charge capacity, then the non-contact charging method ends until the next time interval or the bicycle component BC is operated. On the other hand, if the controller 38 determines the rechargeable power source 32 has not reached the desired fully charge capacity, then the non-contact charging method returns to step S1 to detect the condition of the rechargeable power source 32 and proceed to step S2.

In step S2, if the controller 38 determines a parameter based on the detected condition of the rechargeable power source 32 is outside the permissible range, then, the controller 38 proceeds to step S7.

In step S7, the controller 38 restricts control of the bicycle component BC so that the bicycle component BC cannot be operated, or can be operated only with certain functionality or reduced performance. In other words, the non-contact charging method further comprises restricting an operating function of the bicycle component BC upon determining a parameter of the rechargeable power source 32 is outside of a permissible range. Then, the controller 38 proceeds to step S8.

In step S8, the controller 38 is configured to carry out countermeasures to reduce the temperature of the rechargeable power source 32. In other words, the non-contact charging method further comprises applying thermal management to lower the temperature of the rechargeable power source 32. For example, the rechargeable power source 32 can be cooled using heat pipes, fans, etc. Of course, it will be apparent from this disclosure that step S8 can be omitted or skipped as needed an/or desired. Then, the controller 38 proceeds to step S9.

In step S9, the controller 38 adjusts a voltage of the rechargeable power source 32 to change the charging mode from the preferred charging mode (e.g., a constant current mode) to a charging mode (e.g., a low voltage mode) that is more suitable for the detected condition of the rechargeable power source 32. In the case where a low voltage mode is used for charging the rechargeable power source 32, a voltage supplied to the rechargeable power source 32 is lowered relative to the voltage supplied to the rechargeable power source 32 upon determining the parameter of the rechargeable power source 32 is inside of the permissible range. In other words, the non-contact charging method further comprises adjusting a voltage of the rechargeable power source 32 upon determining the parameter of the rechargeable power source 32 is outside of the permissible range. Then, the controller 38 proceeds to step S6 where the controller 38 determines whether the rechargeable power source 32 is fully charged as discussed below.

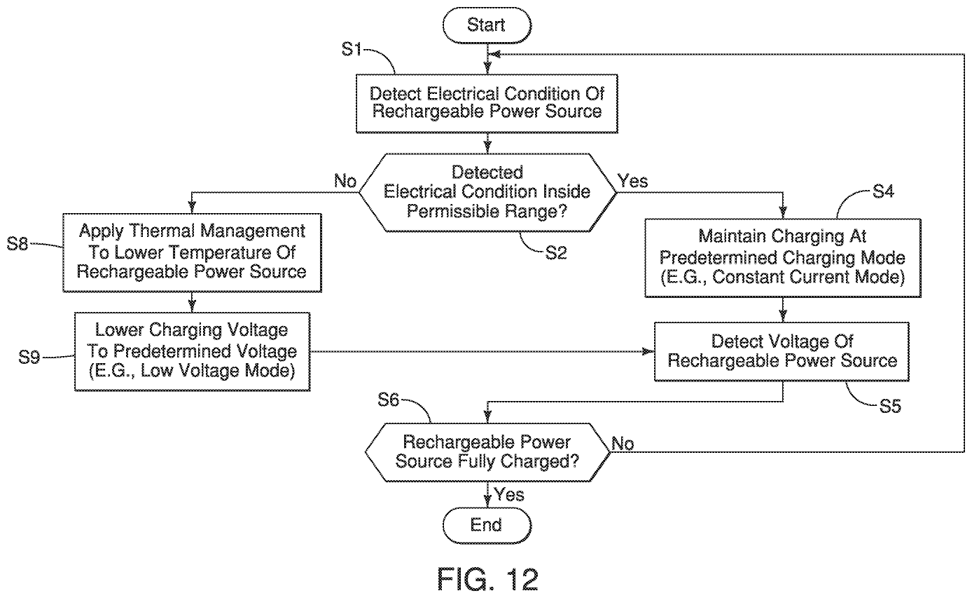

Referring now to FIG. 12, when the controller 38 of the bicycle component BC (12, 12′, 14, 16, 18, 20, 21, 26) determines that the first bicycle B1 or the second bicycle B2 is stopped or when the bicycle component BC is not installed on the bicycle B, it is not necessary to restrict an operating function of the bicycle component BC (12, 12′, 14, 16, 18, 20, 21, 26). Thus, in cases where the first bicycle B1 and the second bicycle B2 is stopped or when the bicycle component BC is not installed on the first bicycle B1 and the second bicycle B2, the non-contact charging method of FIG. 12 is performed for recharging the rechargeable power source 32 for each of the bicycle components BC (12, 12′, 14, 16, 18, 20, 21, 26).

Basically, the non-contact charging method of FIG. 12 is identical to the non-contact charging method of FIG. 11, except that steps S7 and S3 of the non-contact charging method of FIG. 11 have been omitted from the non-contact charging method of FIG. 12. Thus, steps S1, S2, and S4 to S9 of the non-contact charging method of FIG. 12 are the same as steps S1, S2, and S4 to S9 of the non-contact charging method of FIG. 11. For the sake of brevity, the descriptions of steps S1, S2, and S4 to S9 will not be repeated for the non-contact charging method of FIG. 12.

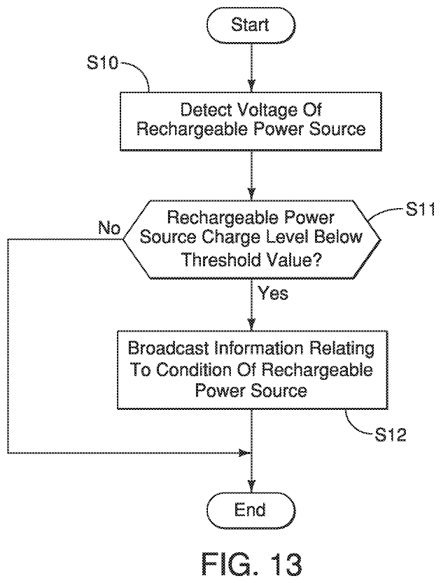

Referring now to FIG. 13, optionally, the controller 38 of each or some of the bicycle components BC (12, 12′, 14, 16, 18, 20, 21, 26) can be configured carry out a process to start recharging the rechargeable power source 32 upon determining the rechargeable power source 32 has fallen below a prescribed charge level. The process of FIG. 13 is executed by the controller 38 at a predetermined time interval and/or each time the electrical part 30 is operated.

Here, in step S10, the controller 38 detects the voltage of the rechargeable power source 32 using the voltage sensor 44B, which either directly detects the voltage of the rechargeable power source 32 or indirectly detects the voltage of the rechargeable power source 32 by detecting the voltage of the electrical part 30. Then, the controller 38 proceeds to step S11.

In step S11, the controller 38 determines whether the charge level of the rechargeable power source has fallen below a threshold value. The threshold valve can be the same for each or some of the bicycle components BC (12, 12′, 14, 16, 18, 20, 21, 26). Alternatively, the threshold valves can be different for each or some of the bicycle components BC (12, 12′, 14, 16, 18, 20, 21, 26). If the controller 38 determines the charge level of the rechargeable power source has fallen below a threshold value, then the controller 38 proceeds to step S12. On the other hand, if the controller 38 determines the charge level of the rechargeable power source has fallen above a threshold value, then process ends until the next time interval or the bicycle component BC is operated.

In step S12, the controller 38 instructs the wireless communicator 36 to broadcast information relating to the condition of the rechargeable power source 32. The information relating to the condition of the rechargeable power source 32 is received by the wireless communicator 52 of one or both of the non-contact charging devices CD (22, 24). In this way, the controller 54 of the power transmitter 60 can control the wireless transfer of electric power from the power source 48 via the non-contact charging coil 50a to the non-contact charging coil 34a of the power receiver 40 of the bicycle component BC (12, 12′, 14, 16, 18, 20, 21, 26).

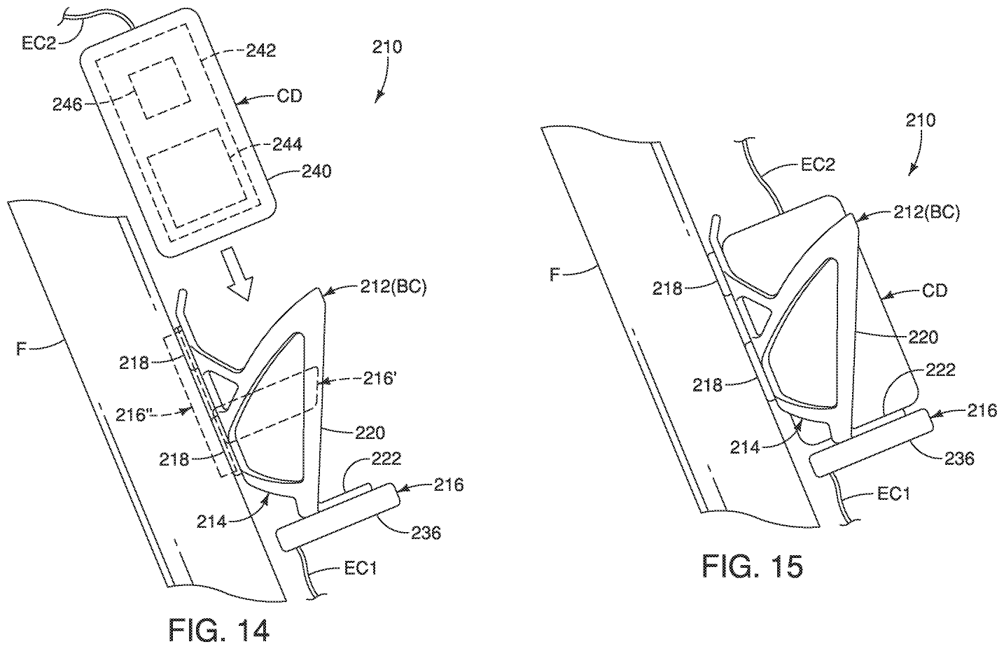

Referring now to FIGS. 14 and 15, a non-contact charging system 210 is illustrated. The non-contact charging system 210 basically comprises a bicycle component BC and a non-contact charging device CD. In this embodiment, the wireless communicators have been omitted from the non-contact charging system 210. However, the wireless communicators of the non-contact charging system 10 can be included in the non-contact charging system 210 if needed and/or desired.

The bicycle component BC (e.g., an object holder 212) basically comprises a base member 214 and a power receiver 216. The power receiver 216 is configured to receive electric power from the non-contact charging device CD. Here, the power receiver 216 includes an electrical cord EC1 that is configured to supply the external electric power to the at least one of a rechargeable power source and an electrical component. In this way, the power receiver 216 can recharge at least one rechargeable power source or supply electric power to at least one electrical component such as one of the bicycle components (12, 12′, 14, 16, 18, 20, 26). The rechargeable power source can be either provided to the power receiver 216 or provided to one of the bicycle components BC (12, 12′, 14, 16, 18, 20, 26) of the first bicycle B1 or the second bicycle B2.

Basically, the non-contact charging device CD can be electrically connected to a power source such the electric power network of a home or a building by an electrical cord EC2. The external electric power received from the electric power network of the home or the building can then be wirelessly transmitted from the non-contact charging device CD to the object holder 212. The non-contact charging device CD is configured to be supported by the object holder 212 to supply external electric power to the power receiver 216 of the object holder 212. In this way, the non-contact charging device CD is supported by the object holder 212 during electric power transfer.

In this embodiment, the object holder 212 can be provided to each of the first bicycle B1 (see, FIG. 1) and the second bicycle B2 (see, FIG. 1). Here, the object holder 212 is configured to hold a bicycle water bottle. However, the object holder 212 is not limited to a bicycle water bottle. Rather, the object holder 212 can be other types of holders such as an air pump holder.

The base member 214 is configured to be mounted to a bicycle (e.g., the first bicycle B1 or the second bicycle B2). In particular, the base member 214 includes at least one mounting portion 218 that is mounted to a braze-on mount of the first bicycle B1 or the second bicycle B2 using at least one fastener. Here, the base member 214 includes a pair of mounting portions 218 that are mounted to a pair of braze-on mounts of the first bicycle B1 or the second bicycle B2 using a pair of fasteners. The base member 214 includes a holding portion 220. The holding portion 220 is configured to removably hold at least one object. Here, the holding portion 220 is configured to hold a water bottle such as a reusable water bottle or a disposable water bottle. In particular, the holding portion 220 supports a side portion of the object or water bottle. The holding portion 220 can also be called a holding portion, a cage, a receptacle, or a clip depending on the structure of the holding portion 220. Thus, the object holder 212 include a water bottle cage in the illustrated embodiment. Also, the holding portion 220 is configured to support the non-contact charging device CD. In this way, the non-contact charging device CD is supported by the object holder 212 during electric power transfer.

The power receiver 216 is mounted to the base member 214. In particular, the base member 132 includes a support portion 222 configured to support the power receiver 216. Here, the support portion 222 is located at the bottom of the holding portion 220 such that a bottom of a water bottle can rest on the support portion 222. The support portion 222 also supports the non-contact charging device CD when the non-contact charging device CD is disposed in the holding portion 220. Alternatively, the support portion 222 can be integrated into the power receiver 216 such that the non-contact charging device CD rest directly onto the power receiver 216.

However, the location of the power receiver 216 is not limited to being located at the support portion 222. Rather, for example, a power receiver 216′ can be located a side portion of the holder portion 220 as indicated in dashed lines in FIG. 14. Also, for example, a power receiver 216″ can be integrated into the mounting portions 218 as indicated in dashed lines in FIG. 14.

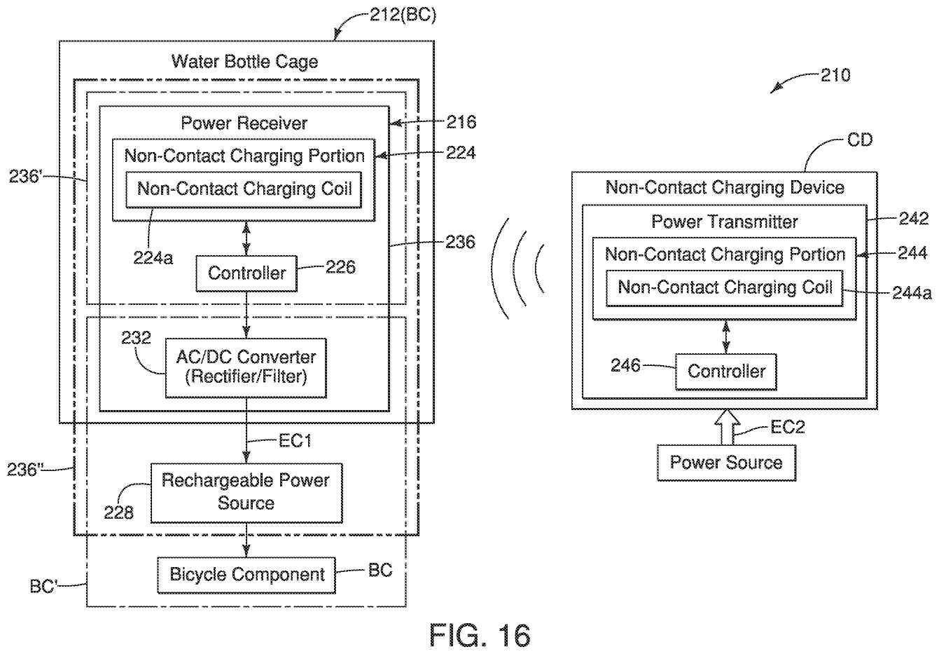

Basically, as seen in FIG. 16, the power receiver 216 includes a non-contact charging portion 224 that is configured to wirelessly receive external electric power and to supply the external electric power to at least one of a rechargeable power source and an electrical component. The non-contact charging portion 224 includes at least a non-contact charging coil 224a. The at least non-contact charging coil 224a can include Near-Field Communication (NFC). Also, as seen in FIG. 16, the power receiver 216 includes a controller 226. The controller 226 is further configured to control the recharging process. The controller 226 is preferably an electronic controller that includes a Central Processing Unit (CPU) or a Micro-Processing Unit (MPU). Preferably, the controller 226 includes one or more processors and one or more storage devices. The memory device stores programs used by the controller 226. The memory device is any computer storage device or any computer readable medium with the sole exception of a transitory propagating signal. For example, the memory device can be nonvolatile memory and volatile memory, and can includes a ROM (Read Only Memory) device, a RAM (Random Access Memory) device, a hard disk, a flash drive, etc.

In this embodiment, the object holder 212 is electrically connected to at least another bicycle component BC (e.g., the bicycle components 12, 12′, 14, 16, 18, 20, 26) by the electrical cord EC1. Here, a rechargeable power source 228 is provided that is separate from the object holder 212 and the bicycle component BC. The rechargeable power source 228 is configured to receive electric power from the non-contact charging portion 224 of the object holder 212.

In this embodiment, the object holder 212 further comprises an AC/DC converter 232. The AC/DC converter 232 converts the alternating current outputted by the non-contact charging portion 224 to direct current that is received by the rechargeable power source 228. In this way, the direct current outputted by the AC/DC converter 232 is used to recharge the rechargeable power source 228.

The bicycle component BC that receives the electric power from the rechargeable power source 228 preferably has a controller, an electrical part and a sensor that are electrically connected to the rechargeable power source 228. The sensor is configured to detect information relating to a condition of the rechargeable power source 228. The sensor is configured to communicate with the controller 230 of the power receiver 216. The sensor 234 can be configured to communicate with the controller of the bicycle component BC which communicates with the controller 226 of the power receiver 216. By employing the sensor, the recharging of the rechargeable power source 228 can be improved based on the condition of the rechargeable power source 228.

The bicycle component BC that receives the electric power from the rechargeable power source 228 also includes an electrical part that receives electric power from the rechargeable power source 228. The electrical part can be a variety of electrical parts, such as an electric motor, an electrical switch, a light emitting diode, or an electric actuator, depending on the bicycle component BC. For example, the electrical part can be an electric motor in a case where the bicycle component BC is a derailleur. The electrical part can be an electrical switch in a case where the bicycle component BC is an operating device. Preferably, the sensor of the bicycle component BC that receives the electric power from the rechargeable power source 228 includes a temperature sensor that configured to detect a temperature of the rechargeable power source 228, and a voltage sensor that is configured to detect at least one of a voltage of the rechargeable power source 228 and a voltage supplied to the rechargeable power source 228. The temperature sensor 234A and the voltage sensor 234B operate in the same manner as the temperature sensor 44A and the voltage sensor 44B that are discussed above.

As seen in FIGS. 14 and 15, the power receiver 216 has a housing 236 that is coupled to the base member 214. As seen in FIG. 16, the housing 236 is configured to accommodate the non-contact charging portion 224, the controller 226 and the AC/DC converter 232. The housing 236 is preferably a waterproof structure. Thus, the power receiver 216 includes a waterproof structure accommodating the non-contact charging portion 224.

Alternatively, as shown by dash-dot-dash lines, the AC/DC converter 232 can be provided to a bicycle component BC′ rather then in the housing 236 of the power receiver 216. Thus, the power receiver 216 has a housing 236′ (shown by dash-dot-dash lines) that accommodate the non-contact charging portion 224 and the controller 226, while the accommodate the non-contact charging portion 224, the controller 226. Alternatively, as shown by dash-dot-dot-dash lines, the power receiver 216 has a housing 236″ that is configured to accommodate the non-contact charging portion 224, the controller 226, rechargeable power source 228, and the AC/DC converter 232.

Here, as seen in FIGS. 14 and 16, the non-contact charging device CD including a housing 240 and a transmitter 242. The housing 240 is configured to be supported by the base member 214. The transmitter 242 is configured to wirelessly transmit electric power to the non-contact charging portion 224. The transmitter 242 is a power transmitter that includes a non-contact charging portion 244 that is configured to wirelessly transmit electric power to the non-contact charging portion 224 of the power receiver 216. The non-contact charging portion 244 includes a non-contact charging coil 244a. The non-contact charging coil 244a can use Near-Field Communication (NFC) to transmit electric power to the non-contact charging portion 224 of the power receiver 216. Alternatively, the non-contact charging coil 244a can use magnetic resonance to transmit electric power to the non-contact charging portion 224 of the power receiver 216.

The transmitter 242 includes a controller 246 to control the power receiver 216 for transmitting electric power from the non-contact charging coil 244a. The controller 246 is preferably an electronic controller that includes a Central Processing Unit (CPU) or a Micro-Processing Unit (MPU). Preferably, the controller 246 includes one or more processors and one or more storage devices. The memory device stores programs used by the controller 246. The memory device is any computer storage device or any computer readable medium with the sole exception of a transitory propagating signal. For example, the memory device can be nonvolatile memory and volatile memory, and can includes a ROM (Read Only Memory) device, a RAM (Random Access Memory) device, a hard disk, a flash drive, etc.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a bicycle in an upright, riding position and equipped with the bicycle component. Accordingly, these directional terms, as utilized to describe the bicycle component should be interpreted relative to a bicycle in an upright riding position on a horizontal surface and that is equipped with the bicycle component. The terms “left” and “right” are used to indicate the “right” when referencing from the right side as viewed from the rear of the bicycle, and the “left” when referencing from the left side as viewed from the rear of the bicycle.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A bicycle component other than a rear derailleur and a drive unit, the bicycle component comprising:
an electrical part;
a rechargeable power source electrically connected to the electrical part; and
a non-contact charging portion configured to wirelessly receive external electric power and to supply the external electric power to the rechargeable power source.

2. The bicycle component according to claim 1, further comprising
a wireless communicator configured to communicate with a non-contact charging device.

3. The bicycle component according to claim 1, further comprising
a sensor configured to detect information relating to a condition of the rechargeable power source.

4. The bicycle component according to claim 3, wherein
the sensor includes a temperature sensor configured to detect a temperature of the rechargeable power source.

5. The bicycle component according to claim 3, wherein
the sensor includes a voltage sensor configured to detect at least one of a voltage of the rechargeable power source and a voltage supplied to the rechargeable power source.

6. The bicycle component according to claim 1, further comprising
an AC/DC converter disposed between the non-contact charging portion and the rechargeable power source.

7. The bicycle component according to claim 1, further comprising
a controller configured to adjust at least one of a voltage supplied to the rechargeable power source and a voltage supplied to the electrical part.

8. The bicycle component according to claim 1, further comprising
a controller configured to monitor at least one of voltage of the rechargeable power source and voltage of the electrical part after a prescribed period of time elapsing from a start of the charging.

9. The bicycle component according to claim 1, further comprising:
a controller configured to restrict an operating function of the electrical part upon determining a parameter of the rechargeable power source is outside of a permissible range, and
the controller being configured to maintain the operating function of the electrical part upon determining the parameter of the rechargeable power source is inside of the permissible range.

10. The bicycle component according to claim 1, wherein
the bicycle component is one of an operating device, an adjustable seatpost, an adjustable suspension, an adjustable front derailleur, a lamp, and an object holder.

11. The bicycle component according to claim 1, wherein
the electrical part includes an electrical switch configured to output an electrical signal to operate an external device.

12. The bicycle component according to claim 11, further comprising
an operating member configured to activate the electrical switch.

13. A non-contact charging system comprising the bicycle component according to claim 1, and further comprising
a non-contact charging device including a non-contact charging portion configured to wirelessly transmit electric power to the bicycle component.

14. A non-contact charging method is provided for charging a rechargeable power source of a bicycle component, the non-contact charging method comprising:
starting wireless communication between the bicycle component and a non-contact charging device;
detecting a condition of the rechargeable power source;
confirming a parameter of the rechargeable power source based on a result of the condition that was detected; and
charging the rechargeable power source of the bicycle component.

15. The non-contact charging method according to claim 14, further comprising
restricting an operating function of the bicycle component upon determining a parameter of the rechargeable power source is outside of a permissible range, and
maintaining the operating function of the bicycle component upon determining the parameter of the rechargeable power source is inside of the permissible range.

16. The non-contact charging method according to claim 15, further comprising
adjusting a voltage of the rechargeable power source upon determining the parameter of the rechargeable power source is outside of the permissible range.

17. The non-contact charging method according to claim 16, further comprising
monitoring the voltage of the rechargeable power source after a prescribed period of time elapsing from a start of the charging.

18. The non-contact charging method according to claim 14, further comprising
detecting a temperature of the rechargeable power source as the condition.

19. The non-contact charging method according to claim 14, further comprising
converting alternating current from a non-contact charging portion to direct current that is supplied to the rechargeable power source.

20. The non-contact charging method according to claim 14, wherein
the bicycle component is one of an operating device, an adjustable seatpost, an adjustable suspension, an adjustable front derailleur, a lamp, and an object holder.

21. A bicycle component other than a rear derailleur and a drive unit, the bicycle component comprising:
a base member configured to be mounted to a bicycle; and
a power receiver mounted to the base member, the power receiver including a non-contact charging portion configured to wirelessly receive external electric power and to supply the external electric power to at least one of a rechargeable power source and an electrical component.

22. The bicycle component according to claim 21, wherein
the base member includes a support portion configured to support the power receiver.

23. The bicycle component according to claim 21, wherein
the bicycle component is one of an operating device, an adjustable seatpost, an adjustable suspension, an adjustable front derailleur, a lamp, and an object holder.

24. The bicycle component according to claim 21, wherein
the power receiver includes an electrical cord that is configured to supply the external electric power to the at least one of the rechargeable power source and the electrical component.

25. The bicycle component according to claim 21, further comprising
an AC/DC converter disposed between the non-contact charging portion and the at least one of the rechargeable power source and the electrical component.

26. The bicycle component according to claim 21, wherein
the rechargeable power source is disposed in the power receiver.

27. The bicycle component according to claim 21, wherein
the power receiver includes a waterproof structure accommodating the non-contact charging portion.

28. A non-contact charging system comprising the bicycle component according to claim 21, and further comprising
a non-contact charging device including a housing configured to be supported by the base member, and a transmitter configured to wirelessly transmit electric power to the non-contact charging portion.
